(19) United States
(12) Patent Application Publication
(10) Pub. No.: US 2026/0260093 A1
(43) Pub. Date: Sep. 3, 2026

(54) GRAPH NEURAL NETWORK-BASED MODEL TRAINING METHOD AND APPARATUS

(71) Applicants: DOUYIN VISION CO., LTD., Beijing (CN); Lemon Inc., Grand Cayman (KY)

(72) Inventors: Yibo ZHU, Beijing (CN); Yangrui CHEN, Beijing (CN); Jun HE, Beijing (CN); Yuan LIN, Beijing (CN); Yanghua PENG, Beijing (CN)

(21) Appl. No.: 18/871,444

(22) PCT Filed: Aug. 4, 2023
(86) PCT No.: PCT/CN2023/111176

§ 371 Date: Dec. 3, 2024

(30) Foreign Application Priority Data
Aug. 18, 2022 (CN) 202210994004.0

(51) Int. Cl. G06N 3/042; G06N 3/09

(52) U.S. Cl. CPC G06N 3/042; G06N 3/09

(57) ABSTRACT

The present disclosure provides a model training method based on a graph neural network, and the method includes: acquiring a first training graph and a label corresponding to the first training graph, wherein the first training graph is a relationship graph corresponding to training multimedia content, or the first training graph is a relationship graph corresponding to a training item; obtaining a position feature, a structure feature, and a node feature of the first training graph based on the first training graph; fusing the position feature, the structure feature, and the node feature, to obtain a fused feature; and training a target model based on the GNN according to the fused feature and the label.

The present application claims priority to Chinese Patent Application No. 202210994004.0, filed with the China National Intellectual Property Administration on Aug. 18, 2022, and entitled “MODEL TRAINING METHOD AND APPARATUS BASED ON GRAPH NEURAL NETWORK”, which is incorporated herein by reference in its entirety.

### TECHNICAL FIELD

The present disclosure relates to the field of data processing, and in particular, to a model training method and apparatus based on a graph neural network.

### BACKGROUND

A model based on a graph neural network (GNN) may be trained to process data, to obtain a corresponding processing result. For example, a model based on a GNN may be used to process multimedia content to predict a label of the multimedia content.

However, when the currently trained model based on the GNN processes data, the obtained processing result is often not particularly accurate. Therefore, there is an urgent need for a solution to solve the foregoing problems.

### SUMMARY

To solve or partially solve the foregoing technical problems, embodiments of the present disclosure provide a model training method and apparatus based on a graph neural network (GNN).

According to a first aspect, an embodiment of the present disclosure provides a model training method based on a graph neural network (GNN), where the method includes:
acquiring a first training graph and a label corresponding to the first training graph, where the first training graph is a relationship graph corresponding to training multimedia content, or the first training graph is a relationship graph corresponding to a training item;
obtaining a position feature, a structure feature, and a node feature of the first training graph based on the first training graph;
fusing the position feature, the structure feature, and the node feature to obtain a fused feature; and
training a target model based on the GNN according to the fused feature and the label.

Optionally, the method further includes:
determining a first importance level of the position feature, and determining a second importance level of the structure feature; and
fusing the position feature, the structure feature, and the node feature to obtain a fused feature includes:
fusing the position feature, the structure feature, and the node feature based on the first importance level and the second importance level to obtain the fused feature.

Optionally, obtaining the position feature of the first training graph based on the first training graph includes:
inputting the first training graph into a position feature extraction module to obtain the position feature corresponding to a target feature space, where a dimension of the target feature space is lower than a dimension of an image space corresponding to the first training graph.

Optionally, the position feature extraction module is obtained through training in the following manner:
acquiring a second training graph;
acquiring position features, corresponding to the target feature space, of nodes in the second training graph;
determining a loss function based on the position features, corresponding to the target feature space, of the nodes in the second training graph and the second training graph; and
adjusting a parameter of the position feature extraction module based on the loss function.

Optionally, determining the loss function based on the position features, corresponding to the target feature space, of the nodes in the second training graph and the second training graph includes:
obtaining the loss function based on loss terms respectively corresponding to the nodes,
where a first node is any node among the nodes, and a loss term corresponding to the first node is determined in the following manner:
obtaining the loss term corresponding to the first node based on a position feature, corresponding to the target feature space, of the first node, a position feature, corresponding to the target feature space, of a second node, and a distance between the first node and the second node in the second training graph, where the second node is a K-th order neighbor node of the first node, and K is an integer greater than or equal to 1.

Optionally, determining the first importance level of the position feature includes:
inputting the position feature into a first model to obtain the first importance level, where the first model is configured to obtain a corresponding importance level based on an input position feature; and
the first model is obtained through training based on a position feature corresponding to a third training graph and a label corresponding to the third training graph.

Optionally, determining the structure feature of the first training graph includes:
obtaining a multi-order neighbor number sequence of the first training graph based on the first training graph, where the multi-order neighbor number sequence is used to indicate numbers of neighbor nodes of respective orders respectively included in nodes in the first training graph, and the structure feature includes the multi-order neighbor number sequence.

Optionally, obtaining the structure feature of the first training graph based on the first training graph includes:
obtaining the multi-order neighbor number sequence of the first training graph and a clustering feature of the first training graph based on the first training graph, where the multi-order neighbor number sequence is used to indicate numbers of neighbor nodes of respective orders respectively included in nodes in the first training graph; and
fusing the multi-order neighbor number sequence and the clustering feature to obtain the structure feature of the first training graph.

Optionally, obtaining the second importance level of the structure feature based on the structure feature includes:
inputting the structure feature into a second model to obtain the second importance level, where the second model is configured to obtain a corresponding importance level based on an input structure feature; and
the second model is obtained through training based on a structure feature corresponding to a fourth training graph and a label corresponding to the fourth training graph.

Optionally, the method further includes:
acquiring a to-be-processed graph, where the to-be-processed graph is a relationship graph corresponding to to-be-processed multimedia content, or the to-be-processed graph is a relationship graph corresponding to a to-be-processed item;
obtaining a position feature, a structure feature, and a node feature of the to-be-processed graph based on the to-be-processed graph;
fusing the position feature, the structure feature, and the node feature of the to-be-processed graph to obtain a fused feature of the to-be-processed graph; and
inputting the fused feature of the to-be-processed graph into the target model to obtain a label of the to-be-processed graph.

According to a second aspect, an embodiment of the present disclosure provides a model training apparatus based on a graph neural network (GNN), where the apparatus includes:
a first acquisition unit, configured to acquire a first training graph and a label corresponding to the first training graph, where the first training graph is a relationship graph corresponding to training multimedia content, or the first training graph is a relationship graph corresponding to a training item;
a first determination unit, configured to obtain a position feature, a structure feature, and a node feature of the first training graph based on the first training graph;
a first fusion unit, configured to fuse the position feature, the structure feature, and the node feature to obtain a fused feature; and
a training unit, configured to train a target model based on the GNN according to the fused feature and the label.

Optionally, the apparatus further includes:
a second determination unit, configured to determine a first importance level of the position feature, and determine a second importance level of the structure feature; and
the first fusion unit is configured to:
fuse the position feature, the structure feature, and the node feature based on the first importance level and the second importance level to obtain the fused feature.

Optionally, obtaining the position feature of the first training graph based on the first training graph includes:
inputting the first training graph into a position feature extraction module to obtain the position feature corresponding to a target feature space, where a dimension of the target feature space is lower than a dimension of an image space corresponding to the first training graph.

Optionally, the position feature extraction module is obtained through training in the following manner:
acquiring a second training graph;
acquiring position features, corresponding to the target feature space, of nodes in the second training graph;
determining a loss function based on the position features, corresponding to the target feature space, of the nodes in the second training graph and the second training graph; and
adjusting a parameter of the position feature extraction module based on the loss function.

Optionally, determining the loss function based on the position features, corresponding to the target feature space, of the nodes in the second training graph and the second training graph includes:
obtaining the loss function based on loss terms respectively corresponding to the nodes,
where a first node is any node among the nodes, and a loss term corresponding to the first node is determined in the following manner:
obtaining the loss term corresponding to the first node based on a position feature, corresponding to the target feature space, of the first node, a position feature, corresponding to the target feature space, of a second node, and a distance between the first node and the second node in the second training graph, where the second node is a K-th order neighbor node of the first node, and K is an integer greater than or equal to 1.

Optionally, determining the first importance level of the position feature includes:
inputting the position feature into a first model, to obtain the first importance level, where the first model is configured to obtain a corresponding importance level based on an input position feature; and
the first model is obtained through training based on a position feature corresponding to a third training graph and a label corresponding to the third training graph.

Optionally, determining the structure feature of the first training graph includes:
obtaining a multi-order neighbor number sequence of the first training graph based on the first training graph, where the multi-order neighbor number sequence is used to indicate numbers of neighbor nodes of respective orders respectively included in nodes in the first training graph, and the structure feature includes the multi-order neighbor number sequence.

Optionally, obtaining the structure feature of the first training graph based on the first training graph includes:
obtaining a multi-order neighbor number sequence and a clustering feature of the first training graph based on the first training graph, where the multi-order neighbor number sequence is used to indicate numbers of neighbor nodes of respective orders respectively included in nodes in the first training graph; and
fusing the multi-order neighbor number sequence and the clustering feature to obtain the structure feature of the first training graph.

Optionally, obtaining the second importance level of the structure feature based on the structure feature includes:
inputting the structure feature into a second model to obtain the second importance level, where the second model is configured to obtain a corresponding importance level based on an input structure feature; and
the second model is obtained through training based on a structure feature corresponding to a fourth training graph and a label corresponding to the fourth training graph.

Optionally, the apparatus further includes:
a second acquisition unit, configured to acquire a to-be-processed graph, where the to-be-processed graph is a relationship graph corresponding to to-be-processed multimedia content, or the to-be-processed graph is a relationship graph corresponding to a to-be-processed item;
a third determination unit, configured to obtain a position feature, a structure feature, and a node feature of the to-be-processed graph based on the to-be-processed graph;
a second fusion unit, configured to fuse the position feature, the structure feature, and the node feature of the to-be-processed graph to obtain a fused feature of the to-be-processed graph; and
a fourth determination unit, configured to input the fused feature of the to-be-processed graph into the target model to obtain a label of the to-be-processed graph.

According to a third aspect, an embodiment of the present disclosure provides a device, which includes a processor and a memory;
the processor is configured to execute instructions stored in the memory, to enable the device to perform the method according to any one of the first aspect.

According to a fourth aspect, an embodiment of the present disclosure provides a computer-readable storage medium, including instructions, where the instructions instruct a device to perform the method according to any one of the first aspect.

According to a fifth aspect, an embodiment of the present disclosure provides a computer program product that, when running on a computer, causes the computer to perform the method according to any one of the first aspect.

The embodiments of the present disclosure have the following advantages.

The embodiments of the present disclosure provide a model training method based on a GNN, which includes: acquiring a first training graph and a label corresponding to the first training graph, where the first training graph is a relationship graph corresponding to training multimedia content, or the first training graph is a relationship graph corresponding to a training item. After the first training graph is obtained, a position feature, a structure feature, and a node feature of the first training graph may be obtained based on the first training graph, and the position feature, the structure feature, and the node feature of the first training graph are fused to obtain a fused feature of the first training graph. Further, a target model based on the GNN is trained based on the fused feature of the first training graph and the label of the first training graph. In the embodiments of the present disclosure, when the target model is trained, in addition to the node feature of the first training graph, the position feature and the structure feature of the first training graph are further considered. Therefore, more effective information is used for training the target model. Correspondingly, when the trained target model processes data, the obtained processing result is also more accurate.

### BRIEF DESCRIPTION OF DRAWINGS

To more clearly describe the technical solutions in the embodiments of the present disclosure, the following briefly describes the drawings required for describing the embodiments. Apparently, the drawings in the following description show merely some embodiments of the present disclosure, and those ordinarily skilled in the art may still derive other drawings from these drawings without creative efforts.

FIG. 1 is a schematic flowchart of a model training method based on a GNN according to an embodiment of the present disclosure;

FIG. 2 is a schematic flowchart of a method for training a position feature extraction module according to an embodiment of the present disclosure;

FIG. 3 is a schematic diagram of a process of training a target model according to an embodiment of the present disclosure; and

FIG. 4 is a schematic diagram of a structure of a model training apparatus based on a GNN according to an embodiment of the present disclosure.

### DETAILED DESCRIPTION

To make those skilled in the art better understand the solutions in the present disclosure, the following clearly and completely describes the technical solutions in the embodiments of the present disclosure with reference to the drawings in the embodiments of the present disclosure. Apparently, the described embodiments are merely some but not all of the embodiments of the present disclosure. All other embodiments obtained by those ordinarily skilled in the art based on the embodiments of the present disclosure without creative efforts shall fall within the protection scope of the present disclosure.

The inventors of the present disclosure have found through research that currently, when a model based on a GNN is trained, model training may be performed based on a node feature of a training graph and a label of the training graph. However, in this case, some information in the training graph is often lost. In an example, some position information in the training graph is lost by using a current training manner, for example, two nodes that are relatively far apart in the training graph but have the same neighborhood structure cannot be distinguished by using the current training manner. In another example, some structure information in the training graph is lost by using the current training manner, for example, two nodes that have the same computation subgraph but have different neighborhood structures cannot be distinguished by using the current training manner.

To solve the foregoing problems, an embodiment of the present disclosure provides a model training method and apparatus based on a GNN.

Various non-limiting implementations of the present disclosure are described in detail below with reference to the drawings.

### Exemplary Method

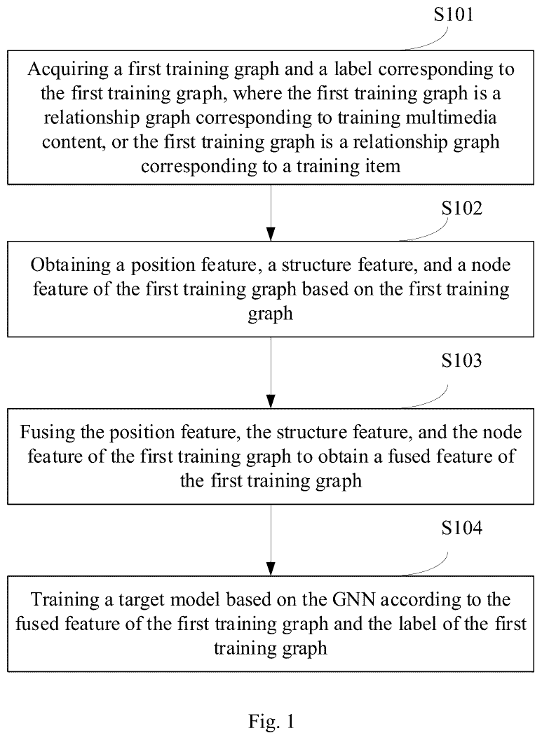

Referring to FIG. 1, FIG. 1 is a schematic flowchart of a model training method based on a GNN according to an embodiment of the present disclosure. In this embodiment, the method may be performed by a terminal device or a server, which is not specifically limited in the embodiments of the present disclosure.

In an example, the method may include the following steps S101 to S104.

It should be noted that the process of model training is a process of multiple iterative computations. In each iteration, a parameter of a model may be adjusted, and the adjusted parameter participates in a next round of iterative computation.

FIG. 1 uses a first training graph as an example to describe an iteration process in training a target model based on a GNN. It may be understood that there are a large number of training graphs used for training the target model, and each training graph is processed in a similar manner when the target model is trained. After a plurality of training graphs are used for training, a target model with a required accuracy can be obtained.

S101: acquiring a first training graph and a label corresponding to the first training graph, where the first training graph is a relationship graph corresponding to training multimedia content, or the first training graph is a relationship graph corresponding to a training item.

In the embodiments of the present disclosure, the first training graph may include a plurality of nodes, and the first training graph may reflect an association relationship between the plurality of nodes. For example, in response to an edge being between node 1 and node 2 in the first training graph, it indicates that node 1 and node 2 have an association relationship.

The label corresponding to the first training graph is not specifically limited in the embodiments of the present disclosure, and the label corresponding to the first training graph is related to a data processing task of the target model. For example, in response to the target model being configured to identify a category of multimedia content, the first training graph may be used to indicate a category of training multimedia content.

Multimedia content mentioned in the embodiments of the present disclosure (for example, the training multimedia content mentioned herein and the to-be-processed multimedia content mentioned below) includes but is not limited to text and/or an image.

In an example, an item mentioned in the embodiments of the present disclosure (for example, the training item mentioned herein and the to-be-processed item mentioned below) may be a commodity, for example.

S102: obtaining a position feature, a structure feature, and a node feature of the first training graph based on the first training graph.

In an example, an image analysis method may be used to analyze the first training graph, to obtain the position feature, the structure feature, and the node feature of the first training graph.

In an example, “obtaining the position feature of the first training graph based on the first training graph” may be implemented by using a position feature extraction module in a specific implementation. Specifically, the first training graph may be input into the position feature extraction module, to obtain the position feature corresponding to the first training graph. The position feature extraction module is configured to extract a position feature of a graph. Therefore, after the first training graph is input into the position feature extraction module, the position feature extraction module may output the position feature of the first training graph. The position feature of the first training graph mentioned in the embodiments of the present disclosure may be a feature that can reflect a position of a node in the first training graph.

In an example, it is considered that for the first training graph, a dimension of an image space corresponding to the first training graph is related to the size of the first training graph, or is related to the quantity of nodes included in the first training graph. The larger the quantity of nodes included in the first training graph, the higher the dimension of the image space. Therefore, in response to the position feature of the first training graph being a feature in the image space, and the quantity of nodes of the first training graph being large, a large amount of computation is consumed to determine the position feature of the first training graph, or even the position feature of the first training graph in the image space cannot be computed. In view of this, in an example, the position feature extraction module may be configured to extract a position feature of a graph in a target feature space. In other words, after the first training graph is input into the position feature extraction module, the position feature extraction module may output a position feature, corresponding to the target feature space, of the first training graph.

The dimension of the target feature space is lower than the dimension of the image space corresponding to the first training graph. In other words, in an example, the target feature space may be a low-dimensional space. In this case, the amount of computation for computing the position feature of the first training graph can be reduced, and even if the first training graph includes a large quantity of nodes, the position feature extraction module can still obtain the position feature of the first training graph.

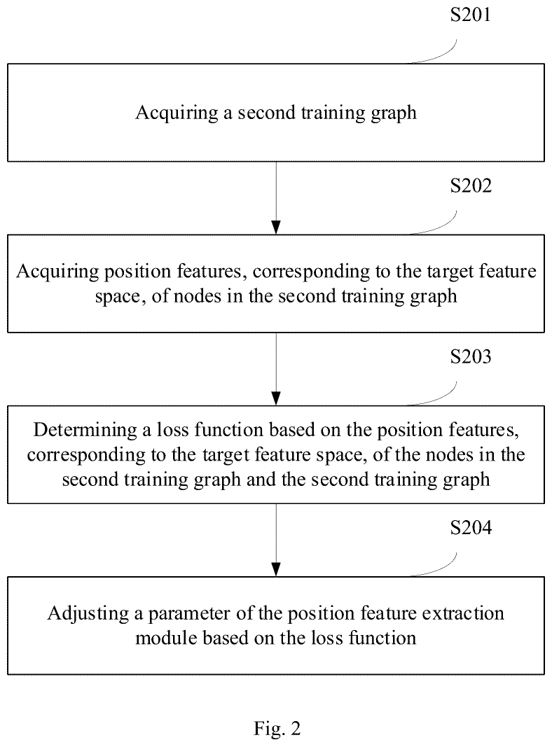

In an example, the position feature extraction module may be obtained through pre-training. The training manner of the position feature extraction module may refer to the description of FIG. 2 below, which will not be detailed here.

In an example, it is considered that for the first training graph, the quantity of neighbor nodes of respective orders included in each node is structure information of the first training graph. Therefore, as an example, when “obtaining the structure feature of the first training graph based on the first training graph” is specifically implemented, a multi-order neighbor number sequence of the first training graph may be obtained based on the first training graph. In this case, the structure feature includes the multi-order neighbor number sequence, and the multi-order neighbor number sequence is used to indicate quantities of neighbor nodes of respective orders respectively included in nodes in the first training graph.

The neighbor nodes of respective orders of a node are described below by using node 1 as an example.

A first-order neighbor node of node 1 refers to a node directly connected to node 1;

a second-order neighbor node of node 1 refers to a node connected to node 1 through one intermediate node, or a node that is separated from node 1 by one intermediate node; and

by analogy, a k-th order neighbor node of node 1 refers to a node connected to node 1 through (k-1) intermediate nodes, or a node that is separated from node 1 by (k-1) intermediate nodes.

In an example, the multi-order neighbor number sequence of the first training graph may be obtained by traversing the first training graph.

In an example, a clustering feature of the first training graph is also structure information of the first training graph. Therefore, in another example, when “obtaining the structure feature of the first training graph based on the first training graph” is specifically implemented, the multi-order neighbor number sequence of the first training graph and the clustering feature of the first training graph may be obtained based on the first training graph, and the multi-order neighbor number sequence and the clustering feature are fused to obtain the structure feature of the first training graph.

For the clustering feature of the first training graph, it should be noted that, in an example, the clustering feature of the first training graph may include the quantity of node loops of respective orders respectively corresponding to the nodes included in the first training graph.

The node loops of respective orders of a node are described below by using node 2 as an example.

A k-th order node loop of node 2 refers to the quantity of loops, in the first training graph, that are each formed by node 2 and a k-th order neighbor node of node 2.

A specific implementation of fusing the multi-order neighbor number sequence and the clustering feature is not specifically limited in the embodiments of the present disclosure. In an example, the multi-order neighbor number sequence and the clustering feature may be superimposed (for example, superimposed in the feature dimension).

In an example, the foregoing “obtaining the structure feature of the first training graph based on the first training graph” may be performed by using a structure feature extraction module.

In an example, when “obtaining the node feature of the first training graph based on the first training graph” is specifically implemented, for example, a node feature extraction module may be used to process the first training graph to obtain the node feature of the first training graph. The node feature extraction module mentioned here may be, for example, a conventional node feature extraction module, and may determine the node feature of the first training graph in a conventional manner of determining the node feature.

S103: fusing the position feature, the structure feature, and the node feature of the first training graph to obtain a fused feature of the first training graph.

After the position feature, the structure feature, and the node feature of the first training graph are obtained, the position feature, the structure feature, and the node feature of the first training graph may be fused to obtain the fused feature of the first training graph.

In an example, the position feature, the structure feature, and the node feature of the first training graph may be fused according to a preset feature fusion manner, to obtain the fused feature of the first training graph.

In another example, when the position feature, the structure feature, and the node feature of the first training graph are fused, a first importance level of the position feature of the first training graph and a second importance level of the structure feature of the first training graph may also be considered, to fuse the position feature, the structure feature, and the node feature of the first training graph, so that the obtained fused feature can be combined with the importance level of the structure feature and the importance level of the position feature of the first training graph. Correspondingly, a feature with a high importance level can contribute more feature information when the target model is trained. Correspondingly, the accuracy of a processing result obtained when the trained target model processes data may be higher.

In an example, the foregoing first importance level and the second importance level may be determined based on a data processing task of the target model. For example, the importance level of a position feature and the importance level of a structure feature that respectively correspond to various data processing tasks may be determined in advance. Correspondingly, the data processing task corresponding to the target model may be matched with “the importance level of the position feature and the importance level of the structure feature that respectively correspond to the various data processing tasks”, to obtain the first importance level and the second importance level.

In another example, the first importance level may be determined based on the position feature of the first training graph. As an example, a first model may be pre-trained, and the first model is configured to obtain a corresponding importance level based on an input position feature. In this case, the position feature of the first training graph may be input into the first model to obtain the first importance level.

The first model is not specifically limited in the embodiments of the present disclosure. As an example, the first model may be a multilayer perceptron (MLP).

In an example, the first model may be, for example, obtained through training based on a position feature corresponding to a third training graph and a label corresponding to the third training graph.

The third training graph may refer to the description of the first training graph above, which will not be detailed here.

The manner of determining the position feature of the third training graph may refer to the manner of determining the position feature of the first training graph. The details may refer to the description of the position feature of the first training graph above, which will not be detailed here.

The label of the third training graph may refer to the description of the label of the first training graph above, which will not be detailed here.

In another example, the second importance level may be determined based on the structure feature of the first training graph. As an example, a second model may be pre-trained, and the second model is configured to obtain a corresponding importance level based on an input structure feature. In this case, the structure feature of the first training graph may be input into the second model to obtain the second importance level.

The second model is not specifically limited in the embodiments of the present disclosure. As an example, the second model may be an MLP.

In an example, the second model may be obtained through training based on a structure feature corresponding to a fourth training graph and a label corresponding to the fourth training graph.

The fourth training graph may refer to the description of the first training graph above, which will not be detailed here.

The manner of determining the structure feature of the fourth training graph may refer to the manner of determining the structure feature of the first training graph. The details may refer to the description of the structure feature of the first training graph above, which will not be detailed here.

The label of the fourth training graph may refer to the description of the label of the first training graph above, which will not be detailed here.

S104: training a target model based on the GNN according to the fused feature of the first training graph and the label of the first training graph.

After the fused feature of the first training graph is obtained, the target model based on the GNN may be trained based on the fused feature of the first training graph and the label of the first training graph. For example, a model prediction result may be obtained based on the fused feature of the first training graph, and then the parameter of the target module is adjusted based on the model prediction result and the label corresponding to the first training graph.

According to the foregoing descriptions, it can be learned that in the embodiments of the present disclosure, when the target model is trained, in addition to the node feature of the first training graph, the position feature and the structure feature of the first training graph are further considered. Therefore, more effective information is used for training the target model. Correspondingly, when the trained target model processes data, an obtained processing result is also more accurate.

Next, with reference to FIG. 2, the training method of the foregoing position feature extraction module is described. FIG. 2 is a schematic flowchart of a method for training a position feature extraction module according to an embodiment of the present disclosure.

The method shown in FIG. 2 may include the following S201 to S204.

S201: acquiring a second training graph.

The second training graph may refer to the description of the first training graph above, which will not be detailed here.

S202: acquiring position features, corresponding to the target feature space, of nodes in the second training graph.

After the second training graph is obtained, the second training graph may be input into the position feature extraction module that is being trained, to obtain the position features, corresponding to the target feature space, of the nodes in the second training graph that are output by the position feature extraction module.

S203: determining a loss function based on the position features, corresponding to the target feature space, of the nodes in the second training graph and the second training graph.

S204: adjusting a parameter of the position feature extraction module based on the loss function.

In a specific implementation of S203, for example, the distance, in the target feature space, between any two nodes in the second training graph may be determined based on the position features, corresponding to the target feature space, of the nodes in the second training graph, the distance between any two nodes in the second training graph is determined based on the second training graph, and then the loss function is determined based on the distance, in the target feature space, between the any two nodes and the distance between the any two nodes in the second training graph.

In an example, it is considered that for the second training graph, in response to the second training graph including a large quantity of nodes, the distance between any two nodes in the second training graph and the distance between the any two nodes in the target feature space are computed for the any two nodes, and the amount of computation for determining the loss function is relatively large. To reduce the amount of computation for determining the loss function, in a specific implementation of S203, for example, the loss function may be obtained based on loss terms respectively corresponding to the nodes. For example, the loss terms respectively corresponding to the nodes may be summed to obtain the loss function.

For example:

the first node is any node among the nodes, and a loss term corresponding to the first node may be obtained based on a position feature, corresponding to the target feature space, of the first node, a position feature, corresponding to the target feature space, of a second node, and a distance between the first node and the second node in the second training graph, where the second node is a K-th order neighbor node of the first node, and K is an integer greater than or equal to 1.

In this case, for the first node, it is not necessary to compute distances between the first node and the nodes in the second training graph in the second training graph and in the target feature space. Because the second node is the K-th order neighbor node of the first node, the distance between the first node and the second node in the second training graph is K. Therefore, according to the solution, it is only necessary to compute the distance, in the target feature space, between the first node and the K-th order neighbor node of the first node, effectively reducing the amount of computation for determining the loss function.

In an example, when “obtaining a loss term corresponding to the first node based on a position feature, corresponding to the target feature space, of the first node, a position feature, corresponding to the target feature space, of a second node, and a distance between the first node and the second node in the second training graph” is specifically implemented, for example, the distance, in the target feature space, between the first node and the second node may be determined based on the position feature, corresponding to the target feature space, of the first node and the position feature, corresponding to the target feature space, of the second node, and then the loss term corresponding to the first node is obtained based on the distance, in the target feature space, between the first node and the second node and the distance between the first node and the second node in the second training graph.

A specific value of K is not specifically limited in the embodiments of the present disclosure. The specific value of K may be determined based on an actual situation, for example.

In an example, the loss term corresponding to the first node may be computed by using the following formula (1):

$${L}_{los} = {[ ( 1 - {d}_{cos} ( {f}_{pos} ( {v}_{i} ) , {f}_{pos} ( {v}_{j} ) ) / 2 - ( 1 - 1 / {d}_{spd} ( {v}_{i} , {v}_{j} ) ) ]}^{2} . \qquad Formula ( 1 )$$

In the formula (1):
Lₗₒₛ is a loss term of the first node;
fₚₒₛ (vᵢ) is a position feature, corresponding to the target feature space, of node i, and node i is the first node;
fₚₒₛ (vⱼ) is a position feature, corresponding to the target feature space, of node j, and node j is the second node;
d_{cos}(fₚₒₛ(vᵢ), fₚₒₛ(vⱼ) is the distance, in the target feature space, between node i and node j; and
d_{spd}(vᵢ, vⱼ) is the distance between node i and node j in the second training graph, and the value of d_{spd}(vᵢ, vⱼ) is k.

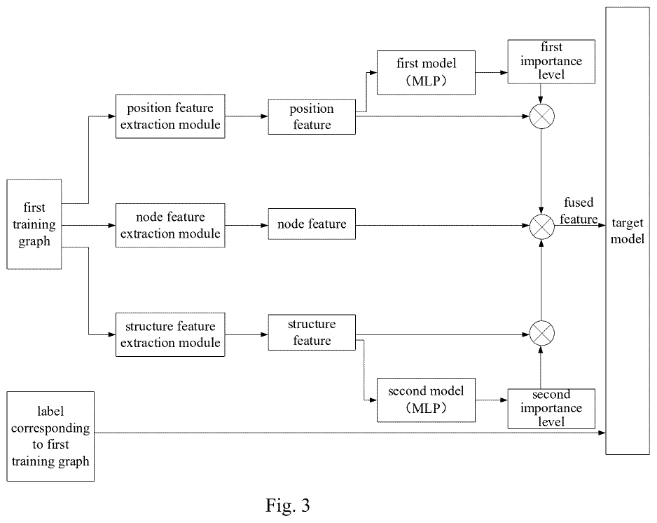

Next, with reference to FIG. 3, a training process of the target model is described.

FIG. 3 is a schematic diagram of a process of training a target model according to an embodiment of the present disclosure.

As shown in FIG. 3:

the position feature extraction module may process the first training graph to obtain the position feature of the first training graph, and the first model may process the position feature of the first training graph to obtain the first importance level.

In addition, a node feature extraction module may process the first training graph to obtain the node feature of the first training graph.

In addition, a structure feature extraction module may process the first training graph to obtain the structure feature of the first training graph, and the second model may process the structure feature of the first training graph to obtain the second importance level.

Then, the position feature, the structure feature, and the node feature of the first training graph are fused based on the first importance level and the second importance level, to obtain the fused feature of the first training graph.

Further, the target model based on the GNN is trained based on the fused feature of the first training graph and the label of the first training graph.

In an example, after the target model is obtained by training, a to-be-processed graph may be processed based on the target model to obtain a label of the to-be-processed graph. In an example, the following steps A1 to A4 may be performed to obtain the label corresponding to the to-be-processed graph.
Step A1: acquiring a to-be-processed graph, where the to-be-processed graph is a relationship graph corresponding to to-be-processed multimedia content, or the to-be-processed graph is a relationship graph corresponding to a to-be-processed item.
Step A2: obtaining a position feature, a structure feature, and a node feature of the to-be-processed graph based on the to-be-processed graph.
Step A3: fusing the position feature, the structure feature, and the node feature of the to-be-processed graph to obtain a fused feature of the to-be-processed graph.

It should be noted that the processing manner of the to-be-processed graph is similar to the processing manner of the first training graph when the target model is trained. Therefore, for steps A1 to A3, a specific implementation manner may refer to steps S101 to S103, which will not be detailed here.

Step A4: inputting the fused feature of the to-be-processed graph into the target model to obtain a label of the to-be-processed graph.

After the fused feature of the to-be-processed graph is obtained, the fused feature of the to-be-processed graph may be input into the target model, to obtain the label of the to-be-processed graph that is output by the target model.

Because when the target model is trained, in addition to the node feature of the first training graph, the position feature and the structure feature of the first training graph are further considered, more effective information is used for training the target model. Correspondingly, when the obtained target model by training processes the to-be-processed graph, an obtained label of the to-be-processed graph is also more accurate.

### Exemplary Device

Based on the method provided in the foregoing embodiments, the embodiments of the present disclosure further provide an apparatus. The apparatus is described below with reference to the drawings.

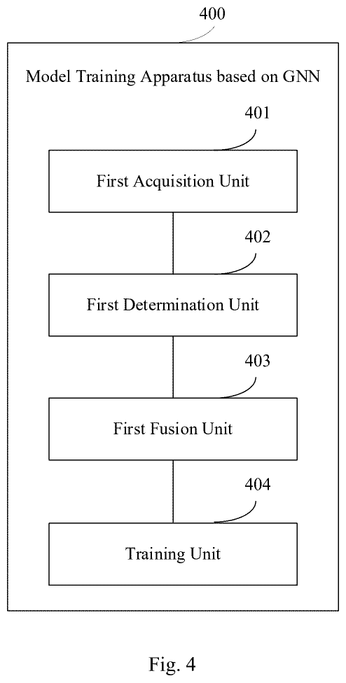

FIG. 4 is a schematic diagram of a structure of a model training apparatus based on a GNN according to an embodiment of the present disclosure. The apparatus 400 may specifically include, for example, a first acquisition unit 401, a first determination unit 402, a first fusion unit 403, and a training unit 404.

The first acquisition unit 401 is configured to acquire a first training graph and a label corresponding to the first training graph, where the first training graph is a relationship graph corresponding to training multimedia content, or the first training graph is a relationship graph corresponding to a training item.

The first determination unit 402 is configured to obtain a position feature, a structure feature, and a node feature of the first training graph based on the first training graph.

The first fusion unit 403 is configured to fuse the position feature, the structure feature, and the node feature to obtain a fused feature.

The training unit 404 is configured to train a target model based on the GNN according to the fused feature and the label.

Optionally, the apparatus further includes:
a second determination unit, configured to determine a first importance level of the position feature, and determine a second importance level of the structure feature; and
the first fusion unit 403 is configured to:
fuse the position feature, the structure feature, and the node feature based on the first importance level and the second importance level to obtain the fused feature.

Optionally, obtaining the position feature of the first training graph based on the first training graph includes:
inputting the first training graph into a position feature extraction module to obtain the position feature corresponding to a target feature space, where the dimension of the target feature space is lower than the dimension of an image space corresponding to the first training graph.

Optionally, the position feature extraction module is obtained through training in the following manner:
acquiring a second training graph;
acquiring position features, corresponding to the target feature space, of nodes in the second training graph;
determining a loss function based on the position features, corresponding to the target feature space, of the nodes in the second training graph and the second training graph; and
adjusting a parameter of the position feature extraction module based on the loss function.

Optionally, determining the loss function based on the position features, corresponding to the target feature space, of the nodes in the second training graph and the second training graph includes:
obtaining the loss function based on loss terms respectively corresponding to the nodes; and
a first node is any node among the nodes, and a loss term corresponding to the first node is determined in the following manner:
obtaining the loss term corresponding to the first node based on a position feature, corresponding to the target feature space, of the first node, a position feature, corresponding to the target feature space, of a second node, and a distance between the first node and the second node in the second training graph, where the second node is a K-th order neighbor node of the first node, and K is an integer greater than or equal to 1.

Optionally, determining the first importance level of the position feature includes:
inputting the position feature into a first model to obtain the first importance level, where the first model is configured to obtain a corresponding importance level based on an input position feature; and
the first model is obtained through training based on a position feature corresponding to a third training graph and a label corresponding to the third training graph.

Optionally, determining the structure feature of the first training graph includes:
obtaining a multi-order neighbor number sequence of the first training graph based on the first training graph, where the multi-order neighbor number sequence is used to indicate numbers of neighbor nodes of respective orders respectively included in nodes in the first training graph, and the structure feature includes the multi-order neighbor number sequence.

Optionally, obtaining the structure feature of the first training graph based on the first training graph includes:
obtaining a multi-order neighbor number sequence and a clustering feature of the first training graph based on the first training graph, where the multi-order neighbor number sequence is used to indicate numbers of neighbor nodes of respective orders respectively included in nodes in the first training graph; and
fusing the multi-order neighbor number sequence and the clustering feature to obtain the structure feature of the first training graph.

Optionally, obtaining the second importance level of the structure feature based on the structure feature includes:
inputting the structure feature into a second model to obtain the second importance level, where the second model is configured to obtain a corresponding importance level based on an input structure feature; and
the second model is obtained through training based on a structure feature corresponding to a fourth training graph and a label corresponding to the fourth training graph.

Optionally, the apparatus further includes:
a second acquisition unit, configured to acquire a to-be-processed graph, where the to-be-processed graph is a relationship graph corresponding to to-be-processed multimedia content, or the to-be-processed graph is a relationship graph corresponding to a to-be-processed item;
a third determination unit, configured to obtain a position feature, a structure feature, and a node feature of the to-be-processed graph based on the to-be-processed graph;
a second fusion unit, configured to fuse the position feature, the structure feature, and the node feature of the to-be-processed graph to obtain a fused feature of the to-be-processed graph; and
a fourth determination unit, configured to input the fused feature of the to-be-processed graph into the target model to obtain a label of the to-be-processed graph.

Because the apparatus 400 is an apparatus corresponding to the method provided in the foregoing method embodiments, specific implementations of the units of the apparatus 400 are all the same concept as the foregoing method embodiments. Therefore, the specific implementations of the units of the apparatus 400 may refer to the description of the foregoing method embodiments, which will not be detailed here.

An embodiment of the present disclosure further provides a device, which includes a processor and a memory;

the processor is configured to execute instructions stored in the memory, to enable the device to perform the model training method based on the GNN according to any one of the foregoing method embodiments.

An embodiment of the present disclosure further provides a computer-readable storage medium, including instructions, where the instructions instruct a device to perform the model training method based on the GNN according to any one of the foregoing method embodiments.

An embodiment of the present disclosure further provides a computer program product that, when running on a computer, causes the computer to perform the model training method based on the GNN according to any one of the foregoing method embodiments.

Those skilled in the art may easily think of other implementation solutions of the present disclosure after considering the specification and practicing the invention disclosed herein. The present disclosure is intended to cover any variation, use, or adaptation of the present disclosure. These variations, uses, or adaptations follow the general principles of the present disclosure and include common knowledge or conventional technical means in the art that are not disclosed in the present disclosure. The specification and embodiments are merely regarded as examples, and the true scope and spirit of the present disclosure are defined by the following claims.

It should be understood that the present disclosure is not limited to the precise structures that have been described above and shown in the drawings, and various modifications and changes may be made without departing from the scope thereof. The scope of the present disclosure is limited only by the appended claims.

The foregoing descriptions are merely preferred embodiments of the present disclosure, and are not intended to limit the present disclosure. Any modification, equivalent replacement, improvement, etc. made within the spirit and principle of the present disclosure shall fall within the scope of protection of the present disclosure.

1. A model training method based on a graph neural network (GNN), comprising:
acquiring a first training graph and a label corresponding to the first training graph, wherein the first training graph is a relationship graph corresponding to training multimedia content, or the first training graph is a relationship graph corresponding to a training item;
obtaining a position feature, a structure feature, and a node feature of the first training graph based on the first training graph;
fusing the position feature, the structure feature, and the node feature to obtain a fused feature; and
training a target model based on the GNN according to the fused feature and the label.

2. The method according to claim 1, further comprising:
determining a first importance level of the position feature, and determining a second importance level of the structure feature;
wherein the fusing the position feature, the structure feature, and the node feature to obtain a fused feature comprises:
fusing the position feature, the structure feature, and the node feature based on the first importance level and the second importance level to obtain the fused feature.

3. The method according to claim 1, wherein obtaining the position feature of the first training graph based on the first training graph comprises:
inputting the first training graph into a position feature extraction module to obtain the position feature corresponding to a target feature space, wherein a dimension of the target feature space is lower than a dimension of an image space corresponding to the first training graph.

4. The method according to claim 3, wherein the position feature extraction module is obtained through training in the following manner:
acquiring a second training graph;
acquiring position features, corresponding to the target feature space, of nodes in the second training graph;
determining a loss function based on the position features, corresponding to the target feature space, of the nodes in the second training graph and the second training graph; and
adjusting at least one parameter of the position feature extraction module based on the loss function.

5. The method according to claim 4, wherein the determining the loss function based on the position features, corresponding to the target feature space, of the nodes in the second training graph and the second training graph comprises:
obtaining the loss function based on loss terms respectively corresponding to the nodes, wherein a first node is any node among the nodes, and a loss term corresponding to the first node is determined in the following manner:
obtaining the loss term corresponding to the first node based on a position feature, corresponding to the target feature space, of the first node, a position feature, corresponding to the target feature space, of a second node, and a distance between the first node and the second node in the second training graph, wherein the second node is a K-th order neighbor node of the first node, and K is an integer greater than or equal to 1.

6. The method according to claim 2, wherein the determining the first importance level of the position feature comprises:
inputting the position feature into a first model to obtain the first importance level, wherein the first model is configured to obtain a corresponding importance level based on an input position feature; and
the first model is obtained through training based on a position feature corresponding to a third training graph and a label corresponding to the third training graph.

7. The method according to claim 1, wherein determining the structure feature of the first training graph comprises:
obtaining a multi-order neighbor number sequence of the first training graph based on the first training graph, wherein the multi-order neighbor number sequence is used to indicate numbers of neighbor nodes of respective orders respectively included in nodes in the first training graph, and the structure feature includes the multi-order neighbor number sequence.

8. The method according to claim 1, wherein obtaining the structure feature of the first training graph based on the first training graph comprises:
obtaining a multi-order neighbor number sequence and a clustering feature of the first training graph based on the first training graph, wherein the multi-order neighbor number sequence is used to indicate numbers of neighbor nodes of respective orders respectively included in nodes in the first training graph; and
fusing the multi-order neighbor number sequence and the clustering feature to obtain the structure feature of the first training graph.

9. The method according to claim 2, wherein determining the second importance level of the structure feature comprises:
inputting the structure feature into a second model to obtain the second importance level, wherein the second model is configured to obtain a corresponding importance level based on an input structure feature; and
the second model is obtained through training based on a structure feature corresponding to a fourth training graph and a label corresponding to the fourth training graph.

10. The method according to claim 1, further comprising:
acquiring a to-be-processed graph, wherein the to-be-processed graph is a relationship graph corresponding to to-be-processed multimedia content, or the to-be-processed graph is a relationship graph corresponding to a to-be-processed item;
obtaining a position feature, a structure feature, and a node feature of the to-be-processed graph based on the to-be-processed graph;
fusing the position feature, the structure feature, and the node feature of the to-be-processed graph to obtain a fused feature of the to-be-processed graph; and
inputting the fused feature of the to-be-processed graph into the target model to obtain a label of the to-be-processed graph.

11. (canceled)

12. A device, comprising a processor and a memory,
wherein the processor is configured to execute instructions stored in the memory, to enable the device to perform a model training method based on a graph neural network (GNN), and the method comprises:
acquiring a first training graph and a label corresponding to the first training graph, wherein the first training graph is a relationship graph corresponding to training multimedia content, or the first training graph is a relationship graph corresponding to a training item;
obtaining a position feature, a structure feature, and a node feature of the first training graph based on the first training graph;
fusing the position feature, the structure feature, and the node feature to obtain a fused feature; and
training a target model based on the GNN according to the fused feature and the label.

13. A non-transitory computer-readable storage medium, comprising instructions, wherein the instructions instruct a device to perform a model training method based on a graph neural network (GNN), and the method comprises:
acquiring a first training graph and a label corresponding to the first training graph, wherein the first training graph is a relationship graph corresponding to training multimedia content, or the first training graph is a relationship graph corresponding to a training item;
obtaining a position feature, a structure feature, and a node feature of the first training graph based on the first training graph;
fusing the position feature, the structure feature, and the node feature to obtain a fused feature; and
training a target model based on the GNN according to the fused feature and the label.

14. (canceled)

15. The device according to claim 12, wherein the method further comprises:
determining a first importance level of the position feature, and determining a second importance level of the structure feature;
wherein the fusing the position feature, the structure feature, and the node feature to obtain a fused feature comprises:
fusing the position feature, the structure feature, and the node feature based on the first importance level and the second importance level to obtain the fused feature.

16. The device according to claim 12, wherein obtaining the position feature of the first training graph based on the first training graph comprises:
inputting the first training graph into a position feature extraction module to obtain the position feature corresponding to a target feature space, wherein a dimension of the target feature space is lower than a dimension of an image space corresponding to the first training graph.

17. The device according to claim 16, wherein the position feature extraction module is obtained through training in the following manner:
acquiring a second training graph;
acquiring position features, corresponding to the target feature space, of nodes in the second training graph;
determining a loss function based on the position features, corresponding to the target feature space, of the nodes in the second training graph and the second training graph; and
adjusting at least one parameter of the position feature extraction module based on the loss function.

18. The device according to claim 17, wherein the determining the loss function based on the position features, corresponding to the target feature space, of the nodes in the second training graph and the second training graph comprises:
obtaining the loss function based on loss terms respectively corresponding to the nodes,
wherein a first node is any node among the nodes, and a loss term corresponding to the first node is determined in the following manner:
obtaining the loss term corresponding to the first node based on a position feature, corresponding to the target feature space, of the first node, a position feature, corresponding to the target feature space, of a second node, and a distance between the first node and the second node in the second training graph, wherein the second node is a K-th order neighbor node of the first node, and K is an integer greater than or equal to 1.

19. The device according to claim 15, wherein the determining the first importance level of the position feature comprises:
inputting the position feature into a first model to obtain the first importance level, wherein the first model is configured to obtain a corresponding importance level based on an input position feature; and
the first model is obtained through training based on a position feature corresponding to a third training graph and a label corresponding to the third training graph.

20. The device according to claim 12, wherein determining the structure feature of the first training graph comprises:
obtaining a multi-order neighbor number sequence of the first training graph based on the first training graph, wherein the multi-order neighbor number sequence is used to indicate numbers of neighbor nodes of respective orders respectively included in nodes in the first training graph, and the structure feature includes the multi-order neighbor number sequence.

21. The device according to claim 12, wherein obtaining the structure feature of the first training graph based on the first training graph comprises:
obtaining a multi-order neighbor number sequence and a clustering feature of the first training graph based on the first training graph, wherein the multi-order neighbor number sequence is used to indicate numbers of neighbor nodes of respective orders respectively included in nodes in the first training graph; and
fusing the multi-order neighbor number sequence and the clustering feature to obtain the structure feature of the first training graph.

22. The device according to claim 15, wherein the determining the second importance level of the structure feature comprises:
inputting the structure feature into a second model to obtain the second importance level, wherein the second model is configured to obtain a corresponding importance level based on an input structure feature; and
the second model is obtained through training based on a structure feature corresponding to a fourth training graph and a label corresponding to the fourth training graph.
